(19) United States
(12) Patent Application Publication
(10) Pub. No.: US 2026/0203876 A1
(43) Pub. Date: Jul. 16, 2026

(54) IMAGE PROCESSING APPARATUS, RADIATION IMAGING SYSTEM, IMAGE PROCESSING METHOD, AND STORAGE MEDIUM STORING PROGRAM

(71) Applicant: CANON KABUSHIKI KAISHA, Tokyo (JP)

(72) Inventor: TSUYOSHI KOBAYASHI, Kanagawa (JP)

(21) Appl. No.: 19/442,881

(22) Filed: Jan. 7, 2026

(30) Foreign Application Priority Data
Jan. 15, 2025 (JP) 2025-005359

(51) Int. Cl. G06T 5/70; G06T 7/246; G06T 7/254

(52) U.S. Cl. CPC G06T 5/70; G06T 7/251; G06T 7/254; G06T 2207/10116; G06T 2207/20081; G06T 2207/20084

(57) ABSTRACT

An apparatus performs processing on a moving image including a first image, a second image acquired before the first image, and a third image acquired before the second image, and the apparatus includes a noise component calculation unit configured to acquire a first signal component and a first noise component of the first image using the first and second images, a noise component weighted addition unit configured to acquire a first weighted noise component using the first noise component and a second noise component obtained using the second and third images, and an output creation unit configured to acquire an image in which noise is reduced compared to the first image using the first signal component and the first weighted noise component.

### BACKGROUND

### Field of the Technology

The aspect of the embodiments relates to an image processing apparatus, a radiation imaging system, an image processing method, and a storage medium storing a program.

### Description of the Related Art

In recent years, a radiation imaging system including a detection unit for detecting radiation such as an X-ray or the like is widely used in the industrial and medical fields and the like. Particularly, in the field of X-ray moving image capturing, a digital radiation imaging system that converts an incident X-ray into visible light using a phosphor and obtains a moving image using a semiconductor sensor is widely prevalent. The “moving image” refers to a set of a plurality of successively collected still images. Hereinafter, an individual still image in the moving image is referred to as a “frame”.

In such a radiation imaging system, diagnostic performance (an indicator indicating the value of an image for a diagnosis) is increased by applying various types of image processing to an image acquired by a semiconductor sensor. Examples of the image processing include a noise reduction process. A phenomenon where in a series of imaging processes, various types of noise such as quantum noise due to a fluctuation in an x-ray quantum, system noise generated from a detector, a circuit, or the like, and the like are generated and superimposed on an image is known. The phenomenon may aggravate the graininess of an obtained moving image and decrease diagnostic performance.

Particularly, in X-ray moving image capturing for medical use, imaging with a low X-ray dosage is recommended in terms of exposure of a subject. Thus, to improve diagnostic performance, it is important to perform image processing for suitably reducing noise on a captured image and improve the image quality.

Further, since the same object is successively captured in moving image capturing, it is important that a signal of the object has little flicker (a phenomenon where the brightness of a moving image fluctuates little by little) between frames.

Further, since it is necessary to obtain a moving image in which a moving object is clearly visible in moving image capturing, it is important that the moving image has little image lag.

Japanese Patent Laid-Open No. 2013-48782 describes a rule-based technique for performing suitable noise reduction. Specifically, Japanese Patent Laid-Open No. 2013-48782 describes a technique for creating a rule that determines a motion with high accuracy from a moving image by considering the influence of noise, and chronologically performing weighted addition on a moving image including a plurality of frames according to the result of the determination.

Further, recently, a higher-performance noise reduction process applying a machine learning based technique such as deep learning or the like is put to practical use. “FastDVDnet: Towards Real-Time Deep Video Denoising Without Flow Estimation”, M Tassano, et.al, IEEE/CVF Conference on Computer Vision and Pattern Recognition (CVPR), 2020, pp. 1354 to 1363 describes a technique for obtaining a noise reduction process image using a neural network trained by inputting frames before and after a frame as a target of noise reduction.

According to Japanese Patent Laid-Open No. 2013-48782, rule-based motion detection and a recursive filter are combined, whereby it is possible to perform weighted addition in which time information and space information regarding a signal are combined using an image of a frame (hereinafter referred to as a “past frame”) before a current frame. The amount of reduction in noise becomes temporally stable by mixing a part of the past frame with the current frame. This results in obtaining the effect of making flicker less likely to occur in a signal. However, in the rule-based motion detection process described in Japanese Patent Laid-Open No. 2013-48782, it is difficult to create an appropriate rule for a variety of motions of an object. Thus, there is a case where image lag occurs according to noise reduction in an object that makes a particularly large number of motions.

According to “FastDVDnet: Towards Real-Time Deep Video Denoising Without Flow Estimation”, M Tassano, et.al, IEEE/CVF Conference on Computer Vision and Pattern Recognition (CVPR), 2020, pp. 1354 to 1363, it is possible to obtain an excellent noise reduction effect in which noise and image lag are reduced by a process applying a machine learning based technique. However, in the configuration described in “FastDVDnet: Towards Real-Time Deep Video Denoising Without Flow Estimation”, M Tassano, et.al, IEEE/CVF Conference on Computer Vision and Pattern Recognition (CVPR), 2020, pp. 1354 to 1363, time information regarding a signal is indirectly used by inputting a plurality of past frames or future frames to the neural network, and output itself is independently calculated with respect to each frame. Thus, there is a case where the amount of reduction in noise is not temporally stable, and flicker occurs in a signal of an object.

### SUMMARY

According to an aspect of the embodiments, an apparatus performs processing on a moving image including a first image, a second image acquired before the first image, and a third image acquired before the second image, and the apparatus includes a calculation unit configured to acquire a first signal component and a first noise component of the first image using the first and second images, an addition unit configured to acquire a first weighted noise component using the first noise component and a second noise component obtained using the second and third images, and a creation unit configured to acquire an image in which noise is reduced compared to the first image using the first signal component and the first weighted noise component.

Features of the disclosure will become apparent from the following description of embodiments with reference to the attached drawings. The following description of embodiments is described by way of example.

### BRIEF DESCRIPTION OF THE DRAWINGS

FIGS. 1A and 1B illustrate examples of schematic configurations of a radiation imaging system and a radiation detector according to a first embodiment.

FIGS. 2A, 2B, and 2C illustrate an example of a schematic configuration of a control unit according to the first embodiment.

FIGS. 3A, 3B, and 3C illustrate examples of a schematic configuration and an operation of a trained model according to the first embodiment.

FIGS. 4A and 4B illustrate flowcharts of an operation of the radiation imaging system according to the first embodiment.

FIGS. 5A and 5B are diagrams for describing an example of an operation of a noise reduction processing unit and images according to the first embodiment.

FIG. 6 is a flowchart of an operation of a radiation imaging system according to a second embodiment.

FIG. 7 is a flowchart of an operation of a radiation imaging system according to a third embodiment.

### DESCRIPTION OF THE EMBODIMENTS

With reference to the drawings, illustrative embodiments for carrying out the present disclosure will be described in detail below.

However, the dimensions, the materials, the shapes, and the relative positions of components described in the following embodiments are optional and can be changed according to the configuration of an apparatus to which the present disclosure is applied or various conditions. In the drawings, the same reference sign is used to indicate the same component or functionally similar components.

A radiation imaging system using an X-ray as an example of radiation is described below. However, the radiation may be an X-ray, or may be other radiation. In the following embodiments, the term “radiation” can include electromagnetic radiation such as an X-ray, a y-ray, and the like, and particle radiation such as an a-ray, a J-ray, a particle beam, a proton beam, a heavy ion beam, a meson beam, and the like.

In the following description, a “machine learning model” refers to a learning model based on a machine learning algorithm. Specific examples of the machine learning algorithm include a nearest neighbor algorithm, a Naive Bayes algorithm, a decision tree, a support-vector machine, and the like. A neural network or deep learning may also be used. An available algorithm among the above algorithms can be appropriately applied to the following embodiments and variations. “Learning data” refers to a data set used to train the machine learning model and is composed of a pair of input data input to the machine learning model and correct answer data (supervised data) as a correct answer for the output result of the machine learning model.

A “trained model” refers to a model obtained by training a machine learning model according to any machine learning algorithm for deep learning using appropriate learning data in advance. However, although the trained model is obtained by learning using the appropriate learning data in advance, it is not that the trained model does not learn any further. The trained model can also perform additional learning. The additional learning can be performed also after an apparatus is installed at a use location.

### First Embodiment

### (Configuration of Radiation Imaging System)

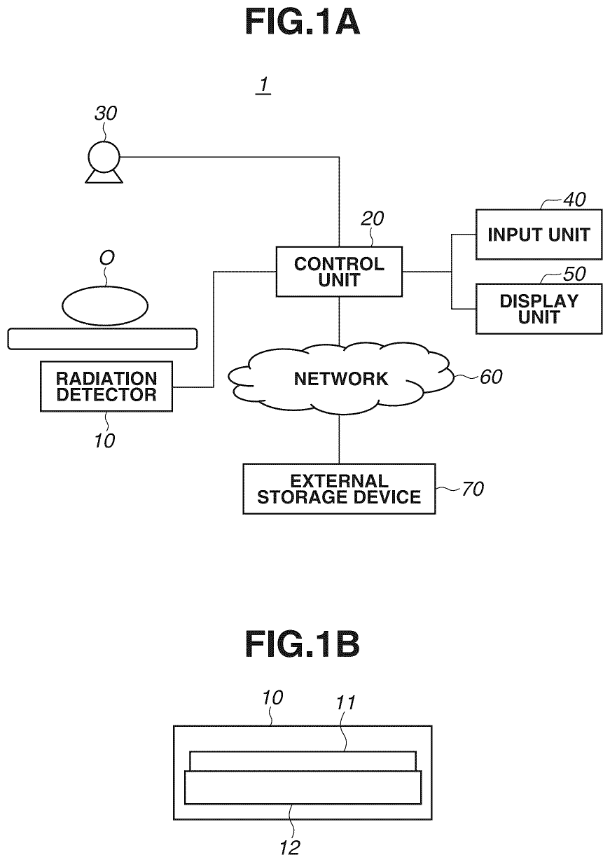

With reference to FIGS. 1A and 1, a description is given below of a radiation imaging system, an image processing apparatus, and an image processing method according to a first embodiment of the present disclosure.

FIG. 1A illustrates an example of the schematic configuration of a radiation imaging system 1 according to the present embodiment.

Although in the following description, an inspection target object O is a human body, the inspection target object O captured by the radiation imaging system according to the present disclosure is not limited to a human body, and may be another animal, a plant, a target object of nondestructive inspection, or the like.

In the radiation imaging system 1 according to the present embodiment, a radiation detector 10, a control unit 20, a radiation generator 30, an input unit 40, and a display unit 50 are provided. The radiation imaging system 1 may include an external storage device 70 such as a server or the like connected to the control unit 20 via a network 60 such as the Internet, an intranet, or the like.

For example, the radiation generator 30 includes a radiation generation source such as an X-ray tube or the like and can emit radiation. The radiation detector 10 can detect radiation emitted from the radiation generator 30 and generate a radiation image corresponding to the detected radiation. Thus, the radiation detector 10 detects radiation emitted from the radiation generator 30 and passing through the inspection target object O and thereby can generate a radiation image of the inspection target object O.

FIG. 1B illustrates an example of the schematic configuration of the radiation detector 10 according to the present embodiment. In the radiation detector 10, a phosphor 11 and an imaging sensor 12 are provided. The phosphor 11 converts radiation incident on the radiation detector 10 into light of a wavelength that can be detected by the imaging sensor 12. For example, the phosphor 11 may include cesium iodide (CsI), gadolinium oxysulfide (GOS (Gd₂O₂S)), or the like.

For example, the imaging sensor 12 includes a photoelectric conversion element composed of amorphous silicon (a-Si) or crystal silicon (Si). The imaging sensor 12 can detect light corresponding to radiation converted by the phosphor 11 and output a signal corresponding to the detected light. The radiation detector 10 performs analog-to-digital (A/D) conversion or the like on the signal output from the imaging sensor 12 and thereby can generate a radiation image.

Although not illustrated in FIG. 1B, the radiation detector 10 may include a calculation unit, an A/D conversion unit, and the like. A grid may be installed between the radiation detector 10 and the inspection target object O so that the radiation detector 10 can reduce scattered radiation that is generated when radiation passes through the inspection target object O, and reaches the radiation detector 10.

The control unit 20 is connected to the radiation detector 10, the radiation generator 30, the input unit 40, and the display unit 50. The control unit 20 can acquire a radiation image output from the radiation detector 10, perform image processing on the radiation image, and control the driving of the radiation detector 10 and the radiation generator 30. Consequently, the control unit 20 can control the radiation generator 30 to generate radiation under a predetermined imaging condition at an appropriate timing and can capture a moving image at any frame rate. The control unit 20 can also function as an example of an image processing apparatus.

The control unit 20 may be connected to the external storage device 70 via any network 60 such as the Internet, an intranet, or the like, and may acquire a radiation image or the like from the external storage device 70. Further, the control unit 20 may be connected to another radiation detector, another radiation generator, or the like via the network 60. The control unit 20 may be connected by wire or connected wirelessly to the external storage device 70 or the like.

The input unit 40 includes input devices such as a mouse, a keyboard, a trackball, a touch panel, and the like and can input an instruction to the control unit 20 by being operated by an operator. For example, the display unit 50 includes any monitor and can display information and an image output from the control unit 20, information input through the input unit 40, and the like.

In the present embodiment, the control unit 20, the input unit 40, the display unit 50, and the like are composed of separate apparatuses, but may be integrally formed. For example, the input unit 40 and the display unit 50 may be composed of a touch panel display. Although in the present embodiment, the image processing apparatus is composed of the control unit 20, in one embodiment, the image processing apparatus only needs to be able to acquire a radiation image and perform image processing on the radiation image, and may not control the driving of the radiation detector 10 and the radiation generator 30.

The control unit 20 may be connected by wire or connected wirelessly to the radiation detector 10, the radiation generator 30, and the like. Further, the external storage device 70 may form an image system such as a picture archiving and communication system (PACS) or the like in a hospital, or may be a server or the like outside a hospital.

### (Configuration of Control Unit)

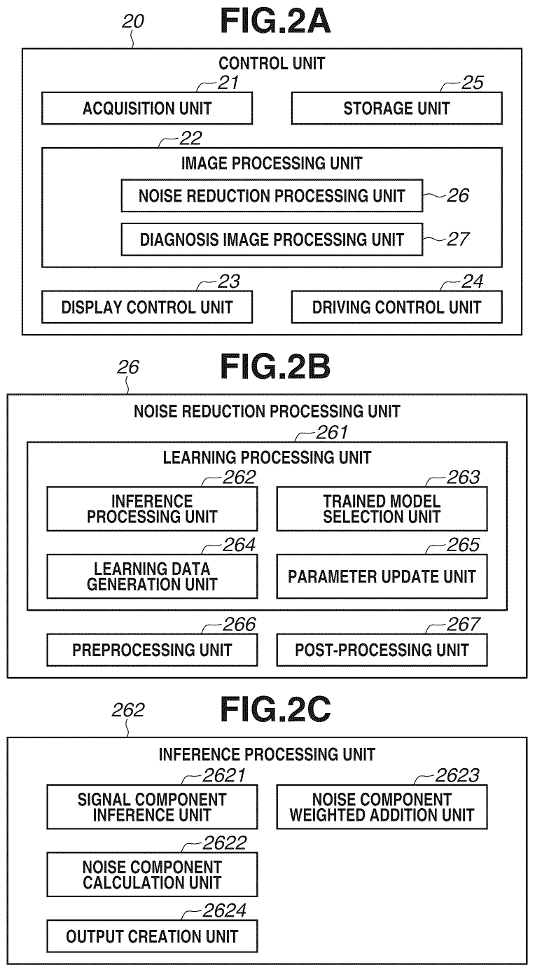

Next, with reference to FIGS. 2A, 2B, and 2C, a more specific configuration of the control unit 20 is described.

FIG. 2A illustrates an example of the schematic configuration of the control unit 20 according to the present embodiment. FIG. 2B illustrates an example of the schematic configuration of a noise reduction processing unit 26 according to the present embodiment.

In the control unit 20, an acquisition unit 21, an image processing unit 22, a display control unit 23, a driving control unit 24, and a storage unit 25 are provided. FIG. 2C illustrates an example of the schematic configuration of an inference processing unit 262 according to the present embodiment.

The acquisition unit 21 can acquire a radiation image output from the radiation detector 10, various pieces of information input through the input unit 40, and the like. The acquisition unit 21 can also acquire a radiation image, patient information, and the like from the external storage device 70 and the like.

In the image processing unit 22, a noise reduction processing unit 26 and a diagnosis image processing unit 27 are provided. The image processing unit 22 can perform image processing according to the present disclosure on a radiation image acquired by the acquisition unit 21. The present embodiment is described taking a noise reduction process as an example of the image processing performed by the image processing unit 22.

As illustrated in FIG. 2B, in the noise reduction processing unit 26, a learning processing unit 261 is provided. In the learning processing unit 261, in addition to components such as an inference processing unit 262 and a trained model selection unit 263, a learning data generation unit 264 and a parameter update unit 265 are provided.

The noise reduction processing unit 26 also includes a preprocessing unit 266 that converts an image input to the noise reduction processing unit 26 into a format suitable for the processing of the learning processing unit 261, and a post-processing unit 267 that applies an appropriate process to the output result of the learning processing unit 261. With this configuration, the noise reduction processing unit 26 can train a machine learning model for performing a noise reduction process. The noise reduction processing unit 26 can also apply a suitable noise reduction process to a radiation image using the trained machine learning model. Alternatively, the noise reduction processing unit 26 may perform a noise reduction process using trained parameters trained by another learning apparatus. That is, the noise reduction processing unit 26 may not have a configuration capable of performing both the training of a machine learning model and a noise reduction process (an inference process using trained parameters).

The diagnosis image processing unit 27 can perform diagnosis image processing for converting an image subjected to noise reduction by the noise reduction processing unit 26 into an image suitable for a diagnosis. For example, the diagnosis image processing includes a gradation process for adjusting the gradation of the image, an emphasis process for emphasizing a particular pixel in the image, a grid stripe reduction process for reducing a grid stripe in the image, and the like. For example, the diagnosis image processing unit 27 may perform the gradation process, the emphasis process, the grid stripe reduction process, and the like according to a region of interest (ROI) set in a radiation image. For example, the gradation process may be performed so that the gradation of the region of interest is wide, or the emphasis process may be performed to emphasize the region of interest. The region of interest may be set according to an instruction from the operator, or may be set based on an imaging target part, disease name information, finding information, or the like.

Next, the configuration of the learning processing unit 261 is described. The learning processing unit 261 performs a learning process applied to train a machine learning model. The learning processing unit 261 includes the inference processing unit 262, the trained model selection unit 263, the learning data generation unit 264, and the parameter update unit 265.

When the learning process is performed, an image subjected to an appropriate process by the preprocessing unit 266 is input to the learning processing unit 261, and the learning data generation unit 264 creates learning data. An example of a configuration is illustrated in which an image to which artificial noise is added (input data) and an image to which artificial noise is not added (correct answer data) are used as a set of pieces of learning data for learning a noise reduction process. The learning data generation unit 264 performs a process of creating a set of pieces of learning data by adding artificial noise created by simulating the feature of a radiation image to an input image. The noise added by the learning data generation unit 264 may reflect the amount of noise that is calculated by the learning data generation unit 264 and can vary depending on the manufacturing variation in the radiation detector 10.

The parameter update unit 265 performs a process of updating parameters of a machine learning model held in the inference processing unit 262 based on the result of calculating input data by the inference processing unit 262 and correct answer data.

If a radiation image is input to a trained model trained using learning data as described above, the inference processing unit 262 performs an inference process, thereby generating an image obtained by applying image processing to the radiation image. The trained model selection unit 263 selects a trained model to be used by the inference processing unit 262. As a trained model obtained by a series of operations of the learning process by the learning processing unit 261, for example, a plurality of trained models may be included with respect to each model of the radiation detector 10. Alternatively, a plurality of trained models may be included with respect to each type of the phosphor 11. Yet alternatively, a plurality of trained models may be included with respect to each type of the imaging sensor 12. Yet alternatively, a plurality of trained models may be included with respect to each of binning, sensitivity, the size of a captured image, a frame rate, and an imaging skill for a single model of the radiation detector 10. The trained model selection unit 263 selects at least one trained model to be used by the inference processing unit 262 among a plurality of trained models.

In the inference processing unit 262, as illustrated in FIG. 2C, a signal component inference unit 2621, a noise component calculation unit 2622, a noise component weighted addition unit 2623, and an output creation unit 2624 are provided. If it is assumed that an input image is composed of the sum of a signal component and a noise component of a captured object, the signal component inference unit 2621 can infer the signal component by performing processing using a trained model. The noise component calculation unit 2622 can obtain the noise component by subtracting the inferred signal component from the input image. The noise component weighted addition unit 2623 performs a process of performing weighted addition on noise components obtained in one or more past frames. The output creation unit 2624 performs a process of creating an output image from the inferred signal component and the weighted noise components subjected to the weighted addition. The detailed operation of the inference processing unit 262 will be described below.

A part of the learning processing unit 261 does not need to be included in the control unit 20. For example, the components other than the inference processing unit 262 and the trained model selection unit 263 may be configured on hardware (a server or the like) separate from the control unit 20. This hardware creates a trained model by performing learning using appropriate learning data in advance. In this case, the control unit 20 may acquire a trained model by the inference processing unit 262 accessing the hardware and perform only processing using the trained model. Alternatively, a trained model may be provided in advance in the noise reduction processing unit 26, and the control unit 20 may perform only processing using the trained model.

Alternatively, a configuration may be employed in which the learning processing unit 261 is included in the control unit 20, whereby additional learning can be performed using learning data acquired after the image processing apparatus is installed in (sold to) a customer.

The display control unit 23 can control the display of the display unit 50. For example, the display control unit 23 can display radiation images before and after being subjected to image processing by the image processing unit 22, patient information, and the like on the display unit 50.

The driving control unit 24 can control the driving of the radiation detector 10, the radiation generator 30, and the like. Thus, the control unit 20 can control the capturing of a radiation image by the driving control unit 24 controlling the driving of the radiation detector 10 and the radiation generator 30.

The storage unit 25 can store programs for achieving various pieces of application software including an operating system (OS), a device driver for a peripheral device, and programs for performing processes and the like described below. The storage unit 25 can also store information acquired by the acquisition unit 21, a radiation image subjected to image processing by the image processing unit 22, and the like. For example, the storage unit 25 can store a radiation image acquired by the acquisition unit 21 and store a radiation image subjected to a noise reduction process.

The control unit 20 can be configured using a general computer including a processor, a memory, and the like, but may be configured as a computer dedicated to the radiation imaging system 1. Although the control unit 20 functions as an example of the image processing apparatus according to the present embodiment, the image processing apparatus according to the present embodiment may be a separate (external) computer connected to the control unit 20 so that the computer can communicate with the control unit 20. For example, the control unit 20 or the image processing apparatus may be a personal computer, and a desktop personal computer (PC), a laptop PC, or a tablet PC (a mobile information terminal) may be used. The processor may be a central processing unit (CPU). For example, the processor may be a microprocessor unit (MPU), a graphics processing unit (GPU), a field-programmable gate array (FPGA), or the like.

The functions of the control unit 20 may be achieved by the processor such as a CPU, an MPU, or the like executing software modules stored in the storage unit 25. For example, the processor may be a GPU, an FPGA, or the like. The functions may be configured by a circuit or the like that serves a particular function, such as an application-specific integrated circuit (ASIC) or the like. For example, the image processing unit 22 may be achieved by dedicated hardware such as an ASIC or the like. The display control unit 23 may be achieved using a dedicated processor such as a GPU or the like different from a CPU. For example, the storage unit 25 may be composed of an optical disc such as a hard disk or the like or any storage medium such as a memory or the like.

### (Configuration of Machine Learning Model)

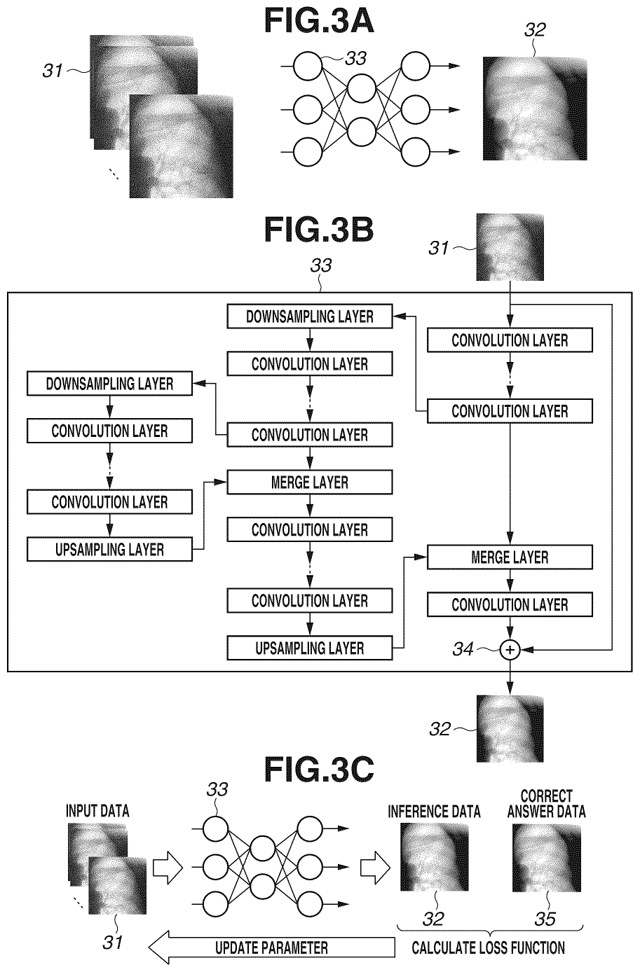

Next, with reference to FIGS. 3A to 3C, an example of a machine learning model forming a trained model according to the present embodiment is described. An example of a machine learning model used by the inference processing unit 262 according to the present embodiment is a multi-layered neural network.

FIG. 3A illustrates an example of the schematic configuration of a neural network model according to the present embodiment. A configuration 33 of the neural network model illustrated in FIG. 3A is designed to output inference data 32 in which noise is reduced compared to input data 31 according to a tendency learned in advance. The inference data 32 in which noise is reduced and which is output is based on the content of learning in a machine learning process. The neural network according to the present embodiment learns a feature amount for sorting a signal and noise included in a radiation image to be input. In the example illustrated in FIG. 3A, the input data 31 includes a current frame and one or more frames in the past earlier than the current frame. Alternatively, the input data 31 includes the current frame and one or more frames in the future. Yet alternatively, the input data 31 includes a group of frames including any of the current frame, one or more frames in the past earlier than the current frame, and a single frame in the future. The inference data 32 in which noise is reduced is a frame obtained by reducing noise in the current frame. A trained model can also be formed so that the input data 31 includes only a single current frame (a single image) and the number of frames to be input is one.

In at least a part of the multi-layered neural network, for example, a convolutional neural network (CNN) can be used. In at least a part of the multi-layered neural network, a technique regarding an autoencoder or a technique regarding a vision transformer (ViT) may be used.

A description is given of an example of a case where a CNN is used as a machine learning model for a noise reduction process on a radiation image. FIG. 3B illustrates an example of a schematic configuration 33 of the CNN forming the neural network model according to the present embodiment. In the example of the trained model according to the present embodiment, if the input data 31 that is a radiation image is input, the inference data 32 can be output as a radiation image in which noise is reduced.

The CNN illustrated in FIG. 3B is composed of a plurality of groups of layers that serves to perform a process of processing a group of input values and outputting the processing results. Examples of the types of layers included in the configuration 33 of the CNN include a convolution layer, a downsampling layer, an upsampling layer, and a merge layer. The configuration 33 of the CNN may further include an addition layer 34 and form a shortcut that adds the input data 31 before output. Consequently, the CNN can employ a configuration for learning the difference between input data and output data and can suitably handle a system targeted at noise.

The convolution layer is a layer that performs a convolution process on a group of input values according to set parameters such as the kernel size of a filter, the number of filters, the value of a stride, the value of dilation, and the like. The number of dimensions of the kernel size of a filter may also be changed according to the number of dimensions of an image to be input.

The downsampling layer is a layer that performs a process of making the number of groups of output values smaller than the number of groups of input values by thinning or combining groups of input values. Specifically, examples of such a process include a max pooling process.

The upsampling layer is a layer that performs a process of making the number of groups of output values greater than the number of groups of input values by duplicating a group of input values or adding a value interpolated from groups of input values.

Specifically, examples of such a process include an upsampling process using deconvolution.

The merge layer is a layer that performs a process of inputting a group of values such as a group of output values of a certain layer or a group of pixel values included in an image from a plurality of sources and combining the group of values by joining the group of values or performing addition.

It should be noted that if the settings of parameters for a group of layers or a group of nodes included in the neural network differ, the degree of reproducibility of a tendency on which the machine learning model is trained using learning data may differ when inference is performed. That is, in many cases, appropriate parameters differ according to the form in which learning is performed, and therefore can be changed, where necessary.

There is a case where the CNN can obtain better characteristics not only by a method for changing parameters as described above, but also by a method for changing the configuration 33 of the CNN. For example, the better characteristics refer to the output of a radiation image in which noise is reduced with higher accuracy, the shortening of the processing time, the shortening of the time taken to train the machine learning model, and the like.

The configuration 33 of the CNN used in the present embodiment is a U-Net machine learning model having the function of an encoder composed of a plurality of hierarchical layers including a plurality of downsampling layers, and the function of a decoder composed of a plurality of hierarchical layers including a plurality of upsampling layers. For example, the U-Net machine learning model can use a skip connection. That is, position information (space information) obscured in the plurality of hierarchical layers configured as the encoder can be used in a hierarchical layer in the same dimension (a hierarchical layer corresponding to a dimension in the encoder) in the plurality of hierarchical layers configured as the decoder.

Although not illustrated, as a variation of the configuration of the CNN, for example, a layer of an activating function (e.g., the rectified linear unit (ReLu)) may be incorporated before or after the convolution layer.

Through these steps of the CNN, it is possible to extract the feature of noise from a radiation image to be input.

The learning processing unit 261 includes the parameter update unit 265. As illustrated in FIG. 3C, the parameter update unit 265 calculates a loss function from the inference data 32 obtained by applying the neural network model of the inference processing unit 262 to the input data 31 in learning data and correct answer data 35 in the learning data. Then, the parameter update unit 265 performs a process of updating parameters of the neural network model based on the calculated loss function.

The loss function indicates the error between the inference data 32 and the correct answer data 35.

The parameter update unit 265 can update a filter coefficient of the convolution layer or the like, for example, using a backpropagation method so that the error between the inference data 32 and the correct answer data 35 indicated by the loss function is small. The backpropagation method is a technique for adjusting a parameter between nodes of the neural network or the like so that the above error is small. For the learning, a technique for randomly inactivating units (neurons or nodes) included in the CNN (a dropout) may be used.

Further, a trained model to be used by the inference processing unit 262 may be generated using transfer learning. In this case, for example, a trained model to be used in a noise reduction process may be generated by performing transfer learning on a machine learning model trained on a radiation image of the inspection target object O different in type or the like. Such transfer learning is performed, whereby it is possible to efficiently generate a trained model also regarding the inspection target object O for which it is difficult to obtain a large number of pieces of learning data. For example, the inspection target object O different in type or the like may be an animal, a plant, a target object of nondestructive inspection, or the like.

A GPU can make efficient calculation by performing parallel processing on more data. Thus, in a case where learning is performed multiple times through use of a machine learning model using a CNN as described above, processing performed by a GPU is effective. Accordingly, the learning processing unit 261 according to the present embodiment is achieved using a GPU in addition to a CPU. Specifically, in a case where a learning program including a machine learning model is executed, the CPU and the GPU collaborate to make calculation, thereby performing learning. In the learning process, the CPU or the GPU alone may make calculation. The processing of the inference processing unit 262 may also be achieved using a GPU similarly to the learning processing unit 261.

While the configuration of a machine learning model has been described above, a machine learning model is not limited to a model using a CNN as illustrated above. The training of a machine learning model used in the present embodiment may be any training classified into machine learning using a model capable of extracting (representing) the feature amount of learning data of an image or the like itself by learning.

The learning processing unit 261 according to the present embodiment can use a set of any pieces of learning data for learning a noise reduction process. For example, the learning processing unit 261 can use learning data in which an image to which artificial noise is added is input data and an image to which artificial noise is not added is correct answer data, and the like. Alternatively, for example, learning may be performed using learning data in which an image before averaging is input data and an image after the averaging is correct answer data, or learning data in which an image before statistical processing such as a maximum a posteriori (MAP) estimation process or the like is input data and an image after the statistical processing is correct answer data. Although examples of supervised learning have been illustrated above, the learning method is not limited to this, and any unsupervised learning or semi-supervised learning technique may be used.

### (Operation of Noise Reduction Processing Unit)

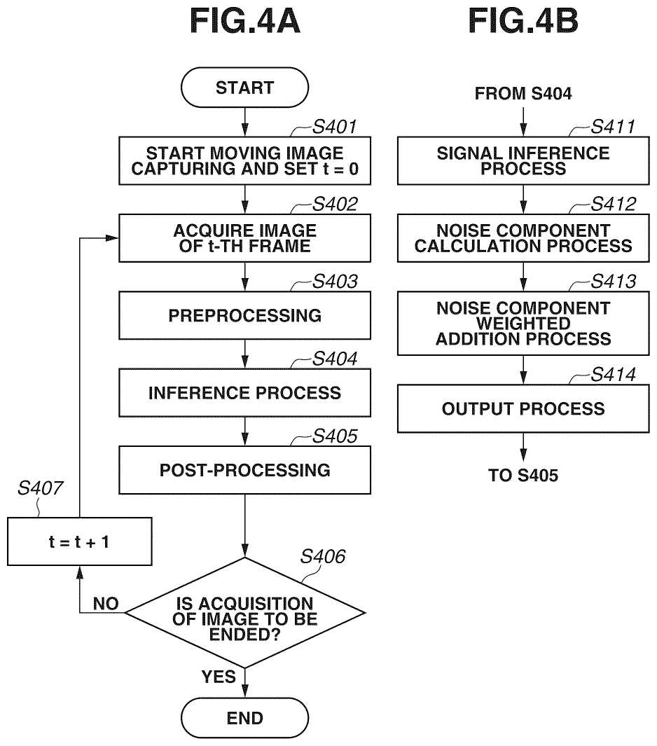

With reference to FIGS. 4A and 4B, the operation of the noise reduction processing unit 26 in moving image capturing is described. A description is given of the operation in a case where trained models in some classes are already prepared, an inference process is performed using any of the trained models in moving image capturing, and an image after a noise reduction process is obtained.

FIG. 4A illustrates an example of the flow of the noise reduction processing unit 26. First, in step S401, if a moving image capturing sequence is started, the noise reduction processing unit 26 sets the number of an initial frame to t=0.

In step S402, the noise reduction processing unit 26 acquires an image of a t-th frame via the acquisition unit 21. The noise reduction processing unit 26 initially acquires the frame t=0 in this state.

In step S403, the preprocessing unit 266 performs preprocessing for performing an appropriate inference process on the image acquired in step S402 and obtains a preprocessed image. The method for the preprocessing is not particularly limited. As the preprocessing, for example, in the noise reduction process, the square root transformation, the logarithm transformation, the Anscombe transform, or the like is performed. These types of transformation can make quantum noise according to the Poisson distribution approximately constant regardless of the intensity of radiation to be emitted. Thus, noise included in an input image can be treated as additive noise. Further, as the preprocessing, appropriate preprocessing can be performed according to the content of image processing. For example, to stabilize processing to be performed by the neural network, centering for setting the average value of data to 0 can be performed. Alternatively, standardization for setting the standard deviation of data to 1 can be performed.

Yet alternatively, normalization for normalizing data to the range of 0 to 1. Yet alternatively, both the centering for setting the average value of data to 0 and the standardization for setting the standard deviation of data to 1 can be performed. If the size of an image to be treated is large, and it is difficult for the neural network to perform batch processing on the image, the image may also be divided into a plurality of ROIs in any sizes. To increase the quality of the calculation result at the boundary of an image, a padding process for obtaining an appropriate size can also be performed.

The result of the preprocessing can be temporarily saved in a memory, where necessary, to be used in an inference process in a subsequent frame. In one embodiment, the preprocessing performed by the preprocessing unit 266 should be the same processing in inference and learning.

In step S404, the inference processing unit 262 performs an inference process using a trained model on the preprocessed image obtained in step S403. The detailed operation of the inference processing unit 262 will be described below. Consequently, it is possible to obtain an image to which the noise reduction process is applied.

In step S405, the post-processing unit 267 performs post-processing on the result of the inference process obtained in step S403. As the post-processing, a process of reversing the processes performed in the preprocessing, such as the inverse transformation of the various processes including the normalization, the standardization, and the like performed in the preprocessing in step S403, the removal of the padded portion, the linking of the plurality of divided ROIs, and the like, is performed.

In step S406, the noise reduction processing unit 26 determines whether to end the acquisition of the image. For example, based on a set imaging condition or an instruction from the operator, the noise reduction processing unit 26 may determine whether to end the acquisition of the image. If the acquisition of the image is to be continued (NO in step S406), the processing proceeds to step S407. In step S407, the noise reduction processing unit 26 adds 1 to the frame number t, and the processing returns to step S402. Then, the noise reduction processing unit 26 repeats the processes of steps S402 to S406.

### (Operation of Inference Processing Unit)

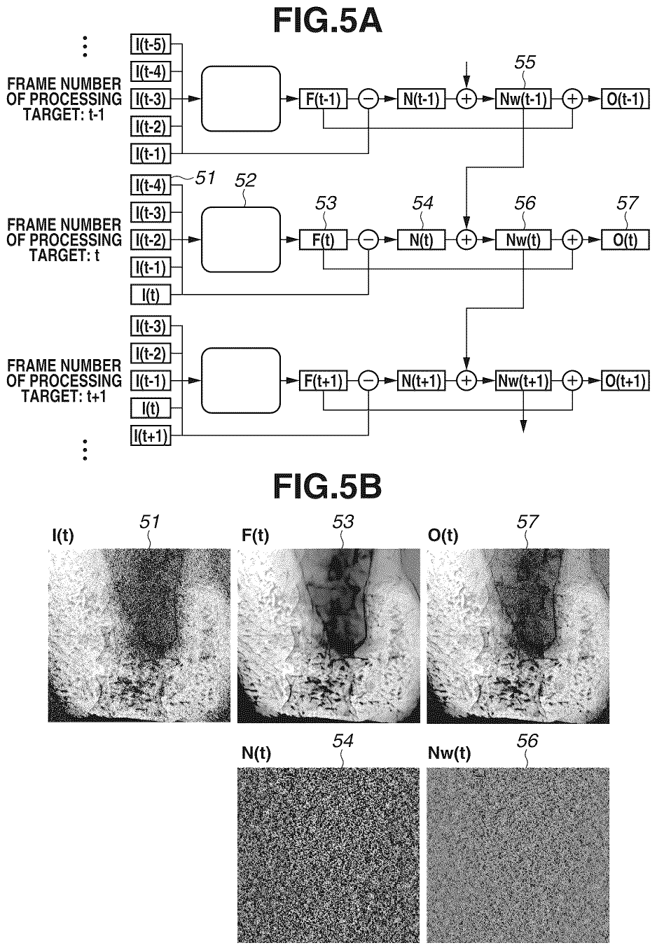

Next, with reference to FIGS. 4B, 5A, and 5B, the detailed operation of the processing of the inference processing unit 262 is described. In moving image capturing, in many cases, a similar structure is often captured in frames in the past or the future near a current frame as a processing target. Thus, when noise reduction is performed on a target pixel in the current frame, a frame in the past or the future near the current frame may be used for input. Consequently, it is possible to use not only spatial information regarding a surrounding similar structure in the same frame or the like, but also temporal information (time information) regarding the similar structure in a frame in the past or the future or the like for noise reduction.

From this viewpoint, the inference processing unit 262 inputs a plurality of frames in the past or the future near the current frame and thereby can perform processing while using more time information. The inference processing unit 262 employs a configuration in which a total of N frames including the current frame and a predetermined number of neighborhood frames are input as frames to be input. Although neighborhood frames in the past or the future that should be used differ depending on the frame rate of imaging or the required noise reduction performance, a description is given below of a case where N=5 frames are input (a case where the current frame and past four frames are input) as a suitable example.

### (Step S411)

FIG. 5A is a schematic diagram illustrating the configuration of the neural network in a case where N=5. FIG. 5A illustrates an example of a case where the number of a frame as a processing target is t−1, t, or t+1. A case is described where the frame number of the current frame as a processing target is t. At the current moment, an input frame of the frame number t is I(t), and a signal component inferred by the signal component inference unit 2621 is F(t) (hereinafter, an inferred signal component is referred to simply as a “signal component”). A noise component calculated by the noise component calculation unit 2622 is N(t), a weighted noise component calculated by the noise component weighted addition unit 2623 is Nw(t), and an output frame calculated by the output creation unit 2624 is O(t).

I(t) is an example of a first frame image. F(t) is an example of a first signal component. N(t) is an example of a first noise component. Nw(t) is an example of a first weighted noise component.

I(t−1) is an example of a second frame image. F(t−1) is an example of a second signal component. N(t−1) is an example of a second noise component. Nw(t−1) is an example of a second weighted noise component.

I(t−2) is an example of a third frame image. F(t−2) is an example of a third signal component. N(t−2) is an example of a third noise component. Nw(t−2) is an example of a third weighted noise component.

FIG. 5B is a diagram illustrating examples of images of the input frame I(t), the signal component F(t), the noise component N(t), the weighted noise component Nw(t), and the output frame O(t).

If the frame number of the current frame as the processing target is t, a plurality of frame images including the processing target frame I(t) is input as an input frame 51 to a neural network 52. Specifically, the processing target frame I(t) and past frames I(t−4) to I(t−1) are input. Similarly to the input frame 51, the neural network 52 stores parameters trained using a set of pieces of learning data in which N=5 successive frames are input data and a correct answer image corresponding to the frame having the number t is correct answer data.

Consequently, the signal component inference unit 2621 performs an inference process using the neural network 52 through use of space information regarding the current frame and time information regarding the four past frames and thereby can obtain a signal component 53 F(t) in which a noise component included in the input frame I(t) is removed.

### (Step S412)

Next, the noise component calculation unit 2622 calculates a noise component 54 N(t) from the input frame 51 I(t) and the signal component 53 F(t) according to formula 1. As illustrated in FIG. 5B, based on the inference process using the neural network 52, the noise component calculation unit 2622, in one embodiment, can calculate only a noise component almost uncorrelated to the signal as the noise component 54 N(t).

$$N ( t ) = I ( t ) - F ( t ) \qquad formula 1$$

### (Step S413)

Next, the noise component weighted addition unit 2623 calculates a weighted noise component 56 Nw(t). Specifically, the noise component weighted addition unit 2623 performs a noise component weighted addition process on a weighted noise component 55 Nw(t−1) in the frame t−1 and the noise component 54 N(t) in the frame t according to formula 2.

$$\begin{matrix}[ Math . 1 ] & \\ Mw ( t ) = α \times Nw ( t - 1 ) + ( 1 - α ) \times N ( t ) ( if t > 0 ) & formula 2\end{matrix}$$

$$Nw ( 0 ) = N ( 0 ) ( if t = 0 )$$

$$where 0 \leq α \leq 1$$

α is a first weighted coefficient. The greater α is, the more information in the past is used. As a result, it is possible to further reduce flicker in an output image. Based on formula 2, as Nw(t), time information regarding a noise component in or before the frame t can be used while the weight is changed according to the value of a. As a result, it is possible to obtain a noise component in which flicker between frames is reduced. On the other hand, as illustrated in FIG. 5B, the noise component calculation unit 2622, in one embodiment, can extract only a component almost uncorrelated to the signal as the noise component 54 N(t).

Thus, even if the noise component weighted addition process is performed, image lag that is issues in conventional techniques is less likely to occur.

An example has been illustrated where the weighted noise component 56 Nw(t) is obtained from the weighted noise component 55 Nw(t−1) in the frame t−1 and the noise component 54 N(t) in the frame t. As another example, as illustrated in formula 3, the noise component weighted addition process may be achieved by multiplying a noise component in each of at least one past frame acquired in the past earlier than the frame t by any coefficient θ and adding the result.

$$\begin{matrix}[ Math . 2 ] & \\ N w ( t ) = {\sum }_{i = k}^{i = t} {θ}_{i} \times N ( i ) & formula 3\end{matrix}$$

$$where 0 \leq k \leq t$$

### (Step S414)

Next, the output creation unit 2624 outputs an output frame 57 O(t) from the signal component 53 F(t) and the weighted noise component 56 Nw(t) according to formula 4.

$$\begin{matrix}[ Math . 3 ] & \\ 0 ( t ) = F ( t ) + β \times N w ( t ) & formula 4\end{matrix}$$

$$where 0 \leq β \leq 1$$

β is a second weighted coefficient. β is multiplied by the weighted noise component 56 Nw(t). It is possible to adjust the amount of noise to be mixed with output by changing β. As a result, it is possible to adjust the intensity of the noise reduction process.

The output creation unit 2624 can also use the signal component 53 F(t) as it is as an output image. However, it is known that in the noise reduction process, the excessive removal of noise may conversely cause a sense of visual discomfort. As a result, there is a case where a diagnostic value (diagnostic performance) is decreased compared to a case where noise is not removed. Thus, as illustrated in formula 4, noise is added to the signal component 53 F(t), whereby it is possible to provide an image that is more natural and has a high diagnostic value.

According to formula 2, there is a case where the amount of noise of the weighted noise component 56 Nw(t) attenuates by the noise component weighted addition process. Specifically, there is a case where the amount of noise added to the output frame 57 O(t) (β×Nw(t) in formula 4) attenuates depending on the value of α. In view of this, the output frame 57 O(t) may be output according to formula 5. According to formula 5, it is possible to compensate for the attenuation of noise associated with the noise component weighted addition process (increase the amount of noise to be added to the output frame 57 O(t)) using an attenuation correction term decay(t).

$$\begin{matrix}[ Math . 4 ] & \\ decay ( t ) = \sqrt{{( α \times decay ( t - 1 ) )}^{2} + {( 1 - α )}^{2}} ( if t > 0 ) & formula 5\end{matrix}$$

$$decay ( 0 ) = 1 ( if t = 0 )$$

$$0 ( t ) = F ( t ) + \frac{β \times Nw ( t )}{decay ( t )}$$

A dedicated user interface (UI) may be placed in the input unit 40 so that the first weighted coefficient α and the second weighted coefficient β can be changed by the operator. For example, the dedicated UI may enable the value of a or the value of β to be changed by inputting the value of α or the value of 3. Alternatively, the dedicated UI may enable the value of α or the value of β to be changed by operating a slider movable in the left-right direction.

If the first weighted coefficient α is made great, flicker between frames becomes small. If the second weighted coefficient β is made great, the effect of the noise reduction process becomes small. The attenuation correction term decay(t) is an example of a first correction term.

A description has been given above of the inference process in a case where the frame number of the processing target is t. However, as illustrated in FIG. 5A, also if the frame number of the processing target is t−1 or t+1, frames I(t−1) to I(t−5) or frames I(t+1) to I(t−3), respectively, are input, whereby it is possible to perform an operation similar to the operation in a case where the frame number is t. That is, the inference processing unit 262 can perform the inference process on any frame number.

Based on the above configuration, it is possible to obtain an image in which image lag is reduced and the amount of reduction in noise is temporally stable (an image with little flicker).

### Second Embodiment

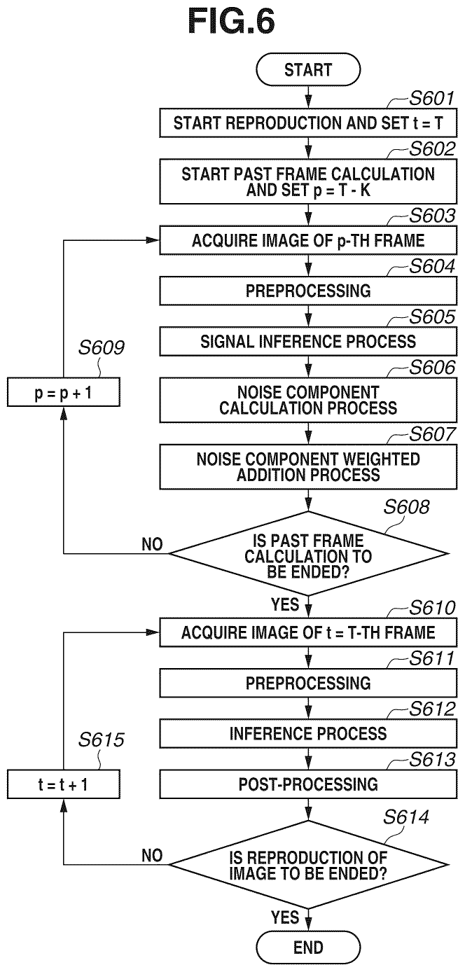

With reference to FIG. 6, an image processing unit according to a second embodiment of the present disclosure is described. Although in the first embodiment, a description has been given of the operation of the image processing unit in a case where image capturing is started from the frame number t=0, a use case where an image captured in advance is reproduced is possible as another operation of the radiation imaging system. Components other than the image processing unit 22 of the radiation imaging system according to the present embodiment are similar to the components of the radiation imaging system 1 according to the first embodiment, and therefore are designated by the same reference signs, and are not described.

FIG. 6 is a diagram illustrating an example of the operation flow of the noise reduction processing unit 26 according to the present embodiment. In a case where an imaging operation is performed in advance and a reproduction process on a moving image saved in the storage unit 25 is performed, the reproduction process can be performed from any frame number. A case is described where the moving image is reproduced from the frame number t=T.

In steps S601 to S608, the noise reduction processing unit 26 processes past frames before the frame number T from which the reproduction is started. The processed past frames are used for an inference process on a frame having the frame number T and subsequent frames in steps S610 to S614.

First, in step S601, if a moving image reproduction sequence is started, the noise reduction processing unit 26 sets the number of an initial frame to t=T. If the number of frames of the moving image saved in the storage unit 25 is N, 0<T<N. As described in the first embodiment, since a noise component weighted addition process is included, the noise reduction processing unit 26 is to retrospectively perform a series of operations of an inference process on past frames before t=T.

In step S602, a past frame calculation sequence is started. The noise reduction processing unit 26 sets the number of a past frame calculation frame to p=T−K. K is the number of past frames to be retrospectively calculated, and 0<K≤T. In terms of the flicker stabilization effect, in one embodiment, T=K (p=0), and the calculation should go back to the first frame. However, the greater K is, the greater the processing cost (the processing amount or the processing time) is. That is, the processing cost and the flicker stabilization effect are in a trade-off relationship.

In step S603, the noise reduction processing unit 26 reads an image having the frame number p as the past frame calculation frame from the storage unit 25.

In step S604, the preprocessing unit 266 performs preprocessing for performing an appropriate inference process on the image acquired in step S603 and obtains a preprocessed image. The details of the preprocessing are similar to those in the first embodiment.

In step S605, the signal component inference unit 2621 applies an inference process using a trained model to the preprocessed image and calculates a signal component.

In step S606, the noise component calculation unit 2622 calculates a noise component from the preprocessed image and the signal component.

In step S607, the noise component weighted addition unit 2623 calculates a weighted noise component.

In step S608, the noise reduction processing unit 26 determines whether to end the past frame calculation sequence. If p=T−1, the past frame sequence is ended (YES in step S608), and the processing proceeds to step S610. If not (NO in step S608), the past frame sequence is continued, and the processing proceeds to step S609. In step S609, the noise reduction processing unit 26 adds 1 to the number p of the past frame calculation frame, and the processing returns to step S603. Then, the noise reduction processing unit 26 repeats the processes of steps S603 to S608.

In step S610, the noise reduction processing unit 26 transitions to a moving image reproduction sequence and acquires an image of an initial frame t=T.

In step S611, the preprocessing unit 266 performs preprocessing for performing an appropriate inference process on the image acquired in step S610 and obtains a preprocessed image.

In step S612, the inference processing unit 262 performs an inference process using a trained model on the preprocessed image obtained in step S611. If the initial frame t=T, the noise component weighted addition unit 2623 uses the weighted noise component calculated in step S607 as initial past information in the noise component weighted addition process.

In step S613, the post-processing unit 267 performs post-processing on the result of the inference process obtained in step S612.

In step S614, the noise reduction processing unit 26 determines whether to end the reproduction of the image. For example, based on an instruction from the operator, the noise reduction processing unit 26 determines whether to end the reproduction of the image. If the reproduction of the image is to be continued (NO in step S614), the processing proceeds to step S615. In step S615, the noise reduction processing unit 26 adds 1 to the frame number t, and the processing returns to step S610. Then, the noise reduction processing unit 26 repeats the processes of steps S610 to S614. If t=N, it is also possible to automatically stop the reproduction of the image, or set t=0 and transition to loop reproduction.

A dedicated UI may be placed in the input unit 40 so that the first weighted coefficient α and the second weighted coefficient β in steps S607 and S612 can be changed by the operator. For example, the dedicated UI may enable the value of α or the value of β to be changed by inputting the value of α or the value of β. Alternatively, the dedicated UI may enable the value of α or the value of β to be changed by operating a slider movable in the left-right direction. The dedicated UI is placed in the input unit 40, whereby also in a case where a moving image saved in the storage unit 25 is reproduced, it is possible to adjust the effect of the noise reduction process and flicker between frames.

Based on the configuration according to the present embodiment, also in a case where a moving image is reproduced, it is possible to obtain an image in which image lag is reduced and the amount of reduction in noise is temporally stable (an image with little flicker).

### Third Embodiment

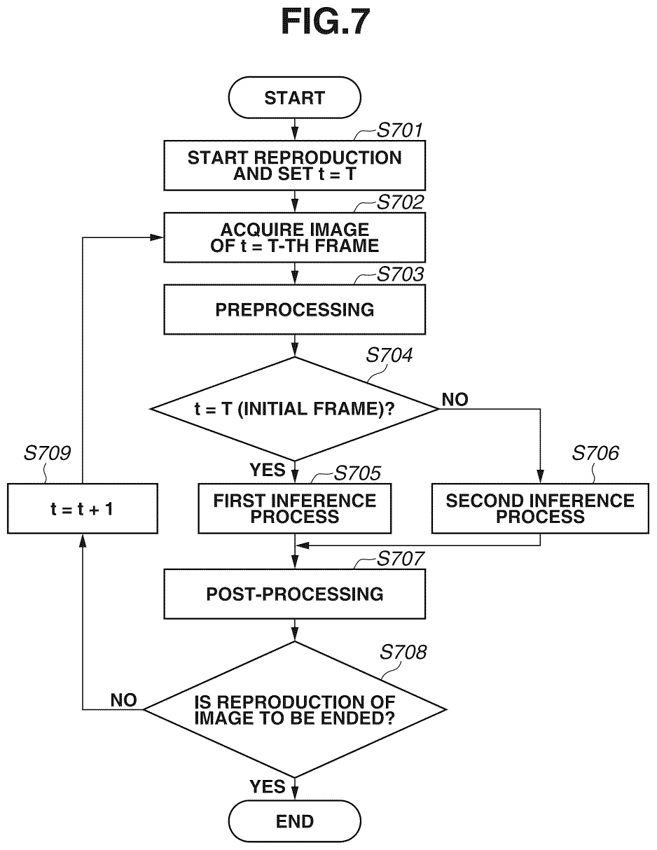

With reference to FIG. 7, an image processing unit according to a third embodiment of the present disclosure is described. The third embodiment illustrates a modified method in the use case where an image captured in advance is reproduced that is described in the second embodiment. Components other than the noise reduction processing unit 26 of the radiation imaging system according to the present embodiment are similar to the components of the radiation imaging system 1 according to each of the first and second embodiments, and therefore are designated by the same reference signs, and are not described.

FIG. 7 is a diagram illustrating an example of the operation flow of the noise reduction processing unit 26 according to the present embodiment. A case is described where an imaging operation is performed in advance and a moving image saved in the storage unit 25 is reproduced from the frame number t=T.

First, in step S701, if a moving image reproduction sequence is started, the noise reduction processing unit 26 sets the number of an initial frame to t=T. If the number of frames of the moving image saved in the storage unit 25 is N, 0<T<N.

In step S702, the noise reduction processing unit 26 transitions to a moving image reproduction sequence and acquires an image of an initial frame t=T.

In step S703, the preprocessing unit 266 performs preprocessing for performing an appropriate inference process on the image acquired in step S702 and obtains a preprocessed image.

In step S704, the noise reduction processing unit 26 determines whether t=T, i.e., whether the image is the initial frame of the reproduction. If the image is the initial frame of the reproduction (YES in step S704), the processing proceeds to step S705. If not (NO in step S704), the processing proceeds to step S706.

In step S705, the inference processing unit 262 performs a first inference process using a trained model on the preprocessed image obtained in step S703. In the first inference process, the noise component weighted addition unit 2623 sets Nw(T)=N(T) without using a weighted noise component retrospectively calculated in a past frame. In the first inference process, similarly to the first embodiment, the signal component inference unit 2621 obtains a signal component 53 F(T) using time information regarding past frames. Similarly to the first embodiment, the noise component calculation unit 2622 obtains a noise component 54 N(T) using formula 1.

In step S706, the inference processing unit 262 performs a second inference process using a trained model on the preprocessed image obtained in step S703. In the second inference process, the noise component weighted addition unit 2623 can use a weighted noise component retrospectively calculated in a past frame. Thus, the noise component weighted addition unit 2623 calculates a weighted noise component Nw(T) according to formula 2.

In step S707, the post-processing unit 267 performs post-processing on the result of the inference process obtained in step S705 or S706.

In step S708, the noise reduction processing unit 26 determines whether to end the reproduction of the image. If the reproduction of the image is to be continued (NO in step S708), the processing proceeds to step S709. In step S709, the noise reduction processing unit 26 adds 1 to the frame number t, and the processing returns to step S702. Then, the noise reduction processing unit 26 repeats the processes of steps S702 to S708. If t=N, it is also possible to automatically stop the reproduction of the image, or set t=0 and transition to loop reproduction.

The present embodiment is characterized in that in a noise reduction process on an initial frame when an image is reproduced, a past frame is not used by the noise component weighted addition unit 2623 to calculate a weighted noise component. When a captured image is reproduced, there is a case where the operator performs an operation of frequently changing a reproduction start frame of a moving image. In such a case, if a process of going back to a past frame to calculate a weighted noise component is performed in a reproduction initial frame as in the second embodiment, it takes a processing time every time the moving image is cued. Thus, there is a possibility that usability decreases. However, based on the third embodiment, even if the operator performs an operation of changing a reproduction start frame of a moving image, the possibility of impairing usability is reduced. Also in the third embodiment, it is possible to obtain an image in which image lag is reduced and the amount of reduction in noise is temporally stable (an image with little flicker).

### (First Variation)

Regarding the machine learning model used by the inference processing unit 262, any layer components such as a variational autoencoder (VAE), a fully convolutional network (FCN), SegNet, DenseNet, and the like can also be used in combination as components of the CNN. For example, the machine learning model may have a configuration in which a ViT is used.

### (Second Variation)

Learning data of various trained models is not limited to data obtained using a radiation detector itself that performs actual image capturing, and may be data obtained using a radiation detector of the same model, data obtained using a radiation detector of the same type, or the like according to a desired configuration. For example, it is considered that the trained model according to each of the above embodiments and variations extracts the relative magnitude of the luminance value, the order, the inclination, the positions, the distribution, and the continuity of light portions and dark portions, and the like of a radiation image as some feature amounts and uses the extracted feature amounts for an estimation process related to the generation of a radiation image subjected to various types of image processing.

The trained model according to each of the above embodiments and variations can be provided in the control unit 20. For example, the trained model may be composed of a software module or the like executed by the processor such as a CPU, an MPU, a GPU, an FPGA, or the like, or may be composed of a circuit or the like that serves a particular function, such as an ASIC or the like. These trained models may be provided in an apparatus or the like of another server connected to the control unit 20. In this case, the control unit 20 can use the trained models by connecting to the server or the like including the trained models, via any network such as the Internet or the like. For example, the server including the trained models may be a cloud server, a fog server, an edge server, or the like.

### (Third Variation)

In each of the above embodiments and variations, the radiation detector 10 is an indirect conversion detector that temporarily converts radiation into visible light using the phosphor 11 and converts the visible light into an electric signal using a photoelectric conversion element. In contrast, the radiation detector 10 may be a direct conversion detector that directly converts incident radiation into an electric signal.

According to the present disclosure, it is possible to provide an image processing apparatus capable of obtaining an image subjected to a suitable noise reduction process and having little image lag and flicker.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-005359, filed Jan. 15, 2025, which is hereby incorporated by reference herein in its entirety.

What is claimed is:

1. An apparatus that performs processing on a moving image including a first image, a second image acquired before the first image, and a third image acquired before the second image, the apparatus comprising:
a calculation unit configured to acquire a first signal component and a first noise component of the first image using the first and second images;
an addition unit configured to acquire a first weighted noise component using the first noise component and a second noise component obtained using the second and third images; and
a creation unit configured to acquire an image in which noise is reduced compared to the first image using the first signal component and the first weighted noise component.

2. The apparatus according to claim 1, wherein the first signal component is acquired by inputting a plurality of images including the first and second images to a trained model.

3. The apparatus according to claim 1, wherein the first noise component is acquired by subtracting the first signal component from the first image.

4. The apparatus according to claim 1, wherein the first weighted noise component is acquired based on a second weighted noise component acquired before the acquisition of the first weighted noise component, the first noise component, and a first weighted coefficient.

5. The apparatus according to claim 4, wherein the first weighted coefficient can be changed by an operation of an operator.

6. The apparatus according to claim 1, wherein the image in which noise is reduced compared to the first image is acquired by adding the first signal component and a noise component obtained by multiplying the first weighted noise component by a second weighted coefficient.

7. The apparatus according to claim 6, wherein the second weighted coefficient can be changed by an operation of an operator.

8. The apparatus according to claim 4, wherein the image in which noise is reduced compared to the first image is acquired using the first signal component, the first weighted noise component, and a first correction term obtained using the first weighted coefficient.

9. The apparatus according to claim 1, wherein in a case where the second image and the first image are reproduced in order of the second image and the first image with the second image as an initial frame by an operation of an operator,
a second signal component and a second noise component of the second image are acquired using the second and third images,
an image in which noise is reduced compared to the second image using the second signal component and the second noise component is displayed as the initial frame,
the first signal component and the first noise component of the first image are acquired using the first and second images,
the first weighted noise component is acquired using the first noise component and the second noise component obtained using the second and third images, and
the image in which noise is reduced compared to the first image using the first signal component and the first weighted noise component is displayed following the initial frame.

10. A system comprising:
a detector configured to detect radiation; and
the apparatus according to claim 1 connected to the detector so that the apparatus can communicate with the detector.

11. An method for an apparatus that performs processing on a moving image including a first image, a second image acquired before the first image, and a third image acquired before the second image, the method comprising:
acquiring a first signal component and a first noise component of the first image using the first and second images;
acquiring a first weighted noise component using the first noise component and a second noise component obtained using the second and third images; and
acquiring an image in which noise is reduced compared to the first image using the first signal component and the first weighted noise component.

12. The method according to claim 11, wherein the first signal component is acquired by inputting a plurality of images including the first and second images to a trained model.

13. The method according to claim 11, wherein the first noise component is acquired by subtracting the first signal component from the first image.

14. The method according to claim 11, wherein the first weighted noise component is acquired based on a second weighted noise component acquired before the acquisition of the first weighted noise component, the first noise component, and a first weighted coefficient.

15. The method according to claim 11, wherein the image in which noise is reduced compared to the first image is acquired by adding the first signal component and a noise component obtained by multiplying the first weighted noise component by a second weighted coefficient.

16. A non-transitory computer-readable storage medium storing a program for causing a computer to execute a method for an apparatus that performs processing on a moving image including a first image, a second image acquired before the first image, and a third image acquired before the second image, the method comprising:
acquiring a first signal component and a first noise component of the first image using the first and second images;
acquiring a first weighted noise component using the first noise component and a second noise component obtained using the second and third images; and
acquiring an image in which noise is reduced compared to the first image using the first signal component and the first weighted noise component.

17. The non-transitory computer-readable storage medium according to claim 16, wherein the first signal component is acquired by inputting a plurality of images including the first and second images to a trained model.

18. The non-transitory computer-readable storage medium according to claim 16, wherein the first noise component is acquired by subtracting the first signal component from the first image.

19. The non-transitory computer-readable storage medium according to claim 16, wherein the first weighted noise component is acquired based on a second weighted noise component acquired before the acquisition of the first weighted noise component, the first noise component, and a first weighted coefficient.

20. The non-transitory computer-readable storage medium according to claim 16, wherein the image in which noise is reduced compared to the first image is acquired by adding the first signal component and a noise component obtained by multiplying the first weighted noise component by a second weighted coefficient.
